(19) United States
(12) Patent Application Publication
(10) Pub. No.: US 2026/0077808 A1
(43) Pub. Date: Mar. 19, 2026

(54) METHOD FOR OPERATING A STEERING SYSTEM MOTOR IN A MOTOR MODE AND A GENERATOR MODE, STEERING SYSTEM HAVING A STEERING SYSTEM MOTOR, AND MOTOR VEHICLE HAVING A STEERING SYSTEM

(71) Applicants: thyssenkrupp Presta AG, Eschen (LI); thyssenkrupp AG, Essen (DE)

(72) Inventors: Tamás Gergely KÁROLY, Sennwald (CH); Thomas PFISTER, Schwarzach (AT); Andreas WILLI, Lauterach (AT); Jenoe GYOEKERES, Budapest (HU)

(73) Assignees: thyssenkrupp Presta AG, Eschen (LI); thyssenkrupp AG, Essen (DE)

(21) Appl. No.: 19/327,862

(22) Filed: Sep. 12, 2025

(30) Foreign Application Priority Data
Sep. 13, 2024 (BE) BE 2024/5622

(51) Int. Cl. B62D 5/04; B62D 1/04; B62D 5/00

(52) U.S. Cl. CPC B62D 5/046; B62D 1/04; B62D 5/006; B62D 5/0409; B62D 5/0418

(57) ABSTRACT

A method for operating a steering system motor in a motor vehicle comprises influencing, by the steering system motor, a steering behavior of a steering handle by means of a motor mode or a generator mode, wherein the steering system motor comprises a first and a second winding group, wherein the first winding group and the second winding group are activated separately from each other, the first via a first circuit arrangement with an assigned first control unit, and the second via a second circuit arrangement with an assigned second control unit, wherein the first circuit arrangement is connected to a first DC voltage source, and the second circuit arrangement is connected to a second DC voltage source. For a torque which is to be provided by the steering system motor and requires a generator mode of the steering system motor, a torque redistribution between the first and the second winding group takes place, the first winding group being activated differently from the second winding group, and a greater negative current flow being permitted with respect to the first winding group than with respect to the second winding group. A steering system having a steering system motor can be operated according to this method and a motor vehicle can have such a steering system.

### CROSS REFERENCE TO RELATED APPLICATION

This application is a U.S. Non-Provisional that claims priority to Belgian Patent Application No. BE 2024/5622, filed Sep. 13, 2024, the entire content of which is incorporated herein by reference.

### FIELD

The present disclosure relates to a method for operating a steering system motor in a motor vehicle.

### BACKGROUND

Furthermore, the invention relates to an electromechanical steering system which comprises a steering system motor, which is coupled to a steering handle of the steering system, and which, during operation of the steering system in a motor vehicle, is designed to influence a steering behavior of the steering handle by means of a motor mode or by means of a generator mode. The steering system motor comprises a first winding group with three first phases and a second winding group with three second phases, wherein, during operation of the steering system, the steering system motor is further designed in such a way that the first winding group and the second winding group can be activated separately from each other, the first via a first circuit arrangement with an assigned first control unit, and the second via a second circuit arrangement with an assigned second control unit.

In addition, the invention relates to a motor vehicle comprising an electromechanical steering system, wherein the motor vehicle comprises two DC voltage sources, which are each connected via a DC bus to a respective winding group of a steering system motor.

It is known from the prior art, in an electromechanical steering system, for redundancy reasons, where a motor is required for converting a steering command into a steering movement of steerable wheels of a motor vehicle, to provide two motors or one motor with two winding groups, which can be activated separately from each other, such motors with two activatable winding groups also being known by the term “dual motor” or “double winding motor”. Such a redundant design, in particular also with regard to the circuit arrangement with a control unit for the activation, is described in DE 10 2020 209 270 A1.

When such a steering system motor is operated, a generator mode, in which electric currents are generated, is problematic because the DC voltage sources and/or the connection to the DC voltage sources are not configured or are no longer configured to receive such generated currents, especially for cost reasons, and the generated currents can thus cause damage to electronic components.

Further redundantly designed circuit arrangements with separate activation of different winding groups are disclosed in the documents US 2022/0134885 A1, U.S. Pat. No. 11,081,995 B2 and CN 108638983 B, with the abovementioned problem also being addressed therein.

Thus a need exists to enable operation of a steering system motor in a motor vehicle in a generator mode, with the intention being to avoid damage due to negative currents, i.e., due to currents generated in the generator mode.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a simplified perspective illustration of an exemplary embodiment of an electromechanical steering system designed according to the invention.

FIG. 2 shows a block diagram for explaining an exemplary embodiment of a method according to the invention for operating a steering system motor during a motor mode.

FIG. 3 shows a block diagram for explaining the exemplary embodiment of a method according to the invention for operating a steering system motor according to FIG. 2 during a generator mode.

FIG. 4 shows a block diagram for explaining a further exemplary embodiment of a method according to the invention for operating a steering system motor according to FIG. 2 during a generator mode.

FIG. 5 shows a simplified circuit diagram of a steering system motor arrangement in a motor vehicle for explaining an exemplary embodiment of a method according to the invention for operating a steering system motor.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The invention relates to a method for operating a steering system motor in a motor vehicle, wherein the steering system motor is coupled to a steering handle of the motor vehicle and, during operation of the motor vehicle, the steering system motor influences a steering behavior of the steering handle by means of a motor mode or a generator mode. The steering system motor comprises a first winding group with three first phases and a second winding group with three second phases, wherein the first winding group and the second winding group are activated separately from each other, the first via a first circuit arrangement with an assigned first control unit, and the second via a second circuit arrangement with an assigned second control unit. The first circuit arrangement is connected to a first DC voltage source, which provides the energy required for a motor mode of the first winding group, and the second circuit arrangement is connected to a second DC voltage source, which provides the energy required for a motor mode of the second winding group.

The proposed solution provides a method for operating a steering system motor in a motor vehicle, wherein the steering system motor is coupled to a steering handle and, during operation of the motor vehicle, the steering system motor influences a steering behavior of the steering handle by means of a motor mode or a generator mode. In particular, it is provided that, in the motor mode, the steering system motor supports a steering movement applied to the steering handle by a vehicle user. It is also provided in particular that, in the generator mode, the steering system motor applies a steering resistance torque to the steering handle. The steering system motor comprises a first winding group with three first phases and a second winding group with three second phases, wherein the first winding group and the second winding group are activated separately from each other, the first via a first circuit arrangement with an assigned first control unit, and the second via a second circuit arrangement with an assigned second control unit. The first circuit arrangement is connected to a first DC voltage source, which provides the energy required for a motor mode of the first winding group, and the second circuit arrangement is connected to a second DC voltage source, which provides the energy required for a motor mode of the second winding group. For a torque which is to be provided by the steering system motor and requires a generator mode of the steering system motor, a torque redistribution between the first winding group and the second winding group takes place, the first winding group being activated differently from the second winding group, and a greater negative current flow being permitted with respect to the first winding group than with respect to the second winding group. In a generator mode of the steering system motor, a torque redistribution is thus advantageously carried out in such a way that the second winding group has, as far as possible, only a little negative current flow, if any at all, and thus in particular, as far as possible, is not operated in the generator mode. Advantageously, the problem of the negative current flow is thus reduced to one part of the two redundant parts, which simplifies the handling of the negative current flow.

Further advantageously, in the generator mode of the steering system motor, the first DC voltage source receives energy generated by the first winding group, wherein in particular a negative current flow is used for charging the first DC voltage source and/or is converted energetically, in particular is converted into thermal energy. Advantageously, therefore, a negative current flow generated by the first winding group can be permitted, because the first DC voltage source is designed in particular to handle, in particular to convert, this negative current flow. Advantageously, further electronic components, which are also connected to the first DC voltage source, in particular via a first DC bus, via which in particular the first winding group is also connected to the first DC voltage source, are thus also kept undamaged.

It is also particularly advantageously provided that the first DC voltage source is a vehicle battery. This vehicle battery is advantageously a “classic” car battery, which does not provide any energy required for driving wheels of the motor vehicle. In particular, the first DC voltage source is a 12V vehicle battery (V: volt), more particularly an AGM battery (AGM: Absorbent Glass Mat). The vehicle battery is advantageously designed to store negative currents and charges. Advantageously, the method therefore further provides that a negative current flow generated by the first winding group in the generator mode is received as excess energy of the steering system motor by the first DC voltage source, in particular by the vehicle battery. Thus, advantageously, damage does not occur due to the currents generated by the first winding group. Since it is further provided in particular that the first DC voltage source, in particular the first vehicle battery, is connected via a first DC bus to the first circuit arrangement, via which the first winding group is activated, and via this first DC bus in particular further electrical loads of the motor vehicle are connected, said further electrical loads are advantageously also protected against damage due to currents generated by the first winding group, thus in particular are protected against a negative current flow caused in the generator mode of the first winding group.

For reasons of redundancy, it is in particular not provided to also connect the second winding group via the second circuit arrangement to the vehicle battery, that is, to the same DC voltage source as the first winding group. For cost reasons and also weight reasons, it is also advantageous in particular not to provide a second vehicle battery as a second DC voltage source, as a result of which negative currents generated by the second winding group might also be correspondingly handled. Instead, it is provided in particular that the second DC voltage source is a drive battery, which is in particular designed to provide energy required for driving wheels of the motor vehicle. In particular, this drive battery is connected to the second circuit arrangement via a unidirectional DC-DC converter. A DC-DC converter converts in particular the higher output voltage of the drive battery into a lower voltage, which is provided in particular via a second DC bus, for operating the second winding group and in particular for operation of further electrical loads, which are connected to this second DC bus. To reduce costs, a unidirectional DC-DC converter is preferably used as the DC-DC converter. However, such a unidirectional DC-DC converter is not designed to process a current flow resulting from a generator mode of the second winding group or to return it to the drive battery. Instead, a negative current flow caused by the second winding group could damage the DC-DC converter, especially if a certain limit value is exceeded. In addition, currents generated by the second winding group could also damage the further electronic components connected to the second DC bus. This is, however, advantageously counteracted by the proposed torque redistribution, which provides that the first winding group is activated differently from the second winding group, and a greater negative current flow is permitted with respect to the first winding group than with respect to the second winding group. This is because in this way the occurrence of a negative current flow caused by the steering system motor on the second DC bus is advantageously already largely prevented, with a negative current flow caused by the steering system motor on the first DC bus advantageously being supplied to the vehicle battery, in particular as charging current.

An advantageous refinement of the method provides that, in the generator mode of the steering system motor, the torque redistribution between the first winding group and the second winding group furthermore takes place in such a way that the generator mode of the steering system motor is implemented up to a defined specification solely by the first winding group. In this case and to this extent, the first winding group advantageously takes over the load of the second winding group. Advantageously, it is thus prevented that negative currents, which could load the second DC bus and electrical loads connected thereto, are generated by the second winding group. The specification is advantageously provided to prevent overload of the first winding group. If the defined specification is exceeded, it is provided in particular that the first winding group continues to be operated in the generator mode only up to the defined specification, and—depending on an evaluation of the requirement of exceeding the specification—either limits the generator mode and thus prevents the specification from being exceeded, or the second winding group is additionally operated in the generator mode. In the generator mode of the steering system motor, the second winding group is further advantageously deactivated up to the defined specification. While the first winding group takes over the load in the generator mode, the second winding group is therefore advantageously shut down, in particular gradually shut down, in particular shut down to zero, which means that it is then no longer actively operated.

A further refinement of the method provides in particular that, in the generator mode of the steering system motor, the torque redistribution between the first winding group and the second winding group furthermore takes place in such a way that the first winding group is operated in the generator mode and the second winding group is operated in the motor mode. By operating the second winding group in the motor mode, there is to this extent a positive current flow, i.e., “current consumption”, with respect to the second winding group. Thus, advantageously, in this refinement, the problem of handling negative currents does not arise for the second winding group and thus also not for the second DC voltage source, which is connected thereto via the circuit arrangement, and for electronic components furthermore connected thereto. Thus, this activation advantageously effectively prevents negative currents from occurring at all by means of the second winding group. Thus, if, for example, the steering system motor requests a resistance torque of −2 Nm (Nm: newton meters), it is provided in this method refinement in particular that the first winding group is activated to provide a resistance torque of −3 Nm and the second winding group is activated to provide a torque of +1 Nm. This results in the required torque of − 2 Nm and prevents the second winding group from being operated in the generator mode. In particular, a different torque distribution is also possible, with the torque distribution advantageously preventing a negative current flow through the second winding group on the second DC bus.

It is further advantageously provided that, with respect to the second winding group, a negative current flow is limited to a predetermined limit value. This limit value can be in particular 0 A (A: amperes), but the limit value can also be set differently, especially depending on the permitted negative currents on the second DC bus. In particular, if the second DC voltage source and/or the electronic components connected to the second winding group in terms of circuitry are robust with respect to a certain negative current flow, a negative current flow can be permitted up to a value evaluated as non-critical for a negative current flow, this value then advantageously corresponding to the limit value. Advantageously, compliance with this limit value further contributes to protection against damage caused by the negative current flow and, in addition, a certain support for the application of a steering resistance torque by means of the second winding group is permitted. Furthermore, it is provided in particular that a negative current flow is limited in such a way that an occurring electrical charge at most at the level of 1.25 C (C: coulombs) or 1.25 As (As: ampere seconds) is permitted. These values can also be defined differently, in particular defined with a deviation of up to 50%.

According to a further advantageous refinement of the method, in the generator mode of the steering system motor, the overall torque which can be provided by the steering system motor is limited to a torque which can be provided by the first winding group. If a higher torque is required, a loss of performance is in particular tolerated. According to one refinement variant, it is also provided that a supporting torque is provided by the second winding group, wherein the supporting torque provided by the second winding group is kept smaller than the torque provided by the first winding group, as a result of which a negative current flow with respect to the second winding group is advantageously kept lower than a negative current flow with respect to the first winding group and thus in particular is also kept lower in comparison to a uniform torque distribution between the two winding groups. If such a supporting torque is permitted by the second winding group, it is provided in particular that said torque is limited in such a way that a negative current flow occurring in the process is limited to the predetermined limit value.

Another advantageous refinement provides that the first circuit arrangement is connected via a first DC bus to the first DC voltage source and the second circuit arrangement is connected via a second DC bus to the second DC voltage source, wherein the torque redistribution between the first winding group and the second winding group takes place if a negative current flow is detected on the second DC bus. Advantageously, a negative current flow on the second DC bus is detected by a sensor unit. Advantageously, when a negative current flow is detected, a change in a uniform torque distribution between the first winding group and the second winding group to torque redistribution takes place. Advantageously, this further contributes to the prevention of damage by a negative current flow, caused by the steering system motor, on the second DC bus.

In particular, it is provided that, in a fault-free motor mode of the steering system motor, i.e. in particular if there is no fault in the system, a uniform torque distribution between the first winding group and the second winding group takes place. Advantageously, the first winding group and the second winding group are activated in the same manner. If the steering system motor is intended to provide, for example, a torque of 6 Nm, it is provided in this refinement that the first winding group and the second winding group contribute in the same manner to the provision of this torque, i.e., in particular provide a torque of 3 Nm in each case.

Further advantageously, a torque distribution unit is provided, with which the torque distribution between the first winding group and the second winding group is controlled. According to a development of this refinement, it is advantageously provided that the torque distribution unit controls a switching element, which can open and close an electrically conductive connection between the second circuit arrangement assigned to the second winding group and the second DC voltage source. Advantageously, the torque distribution unit controls the switching element when a negative current flow is detected on the second DC bus, such that said switching element opens the electrically conductive connection and thus prevents a current return flow in the direction of the second DC voltage source.

According to a further advantageous refinement, during the operation of the steering system motor, the first control unit and the second control unit determine an available torque for the first winding group and the second winding group, wherein a torque distribution unit distributes a required torque to the first winding group and the second winding group, taking into account the torque available for the first winding group and the second winding group, in particular in a generator mode of the steering system motor.

A negative current flow caused by the steering system motor is influenced in particular by three factors. This includes in particular the reference torque of the steering system motor, wherein the sign of the torque in the generator mode is opposite to the sign of the angular speed of the steering system motor. Furthermore, a negative current flow is influenced in particular by the motor speed itself, with a higher speed in the generator mode leading to a higher negative current flow in the generator mode. In addition, a negative current flow brought about depends on the DC voltage brought about.

Another advantageous embodiment of the method provides that the first circuit arrangement is connected via a first DC bus to the first DC voltage source and the second circuit arrangement is connected via a second DC bus to the second DC voltage source, wherein a voltage applied to the second DC bus is monitored. The torque redistribution between the first winding group and the second winding group is advantageously carried out taking into account the voltage applied to the second DC bus. In particular, torque redistribution occurs when the voltage applied to the second DC bus exceeds a predefined limit value. Advantageously, the torque redistribution takes place in such a way that the voltage applied to the second DC bus complies with the predefined limit value.

Advantageously, thus, the second winding group can also be operated in generator mode as long as the voltage applied to the second DC bus does not exceed the predefined limit value, wherein the second winding group can generate a correspondingly greater torque portion and thus can recover correspondingly more energy the more energy is consumed on the second DC bus by the electronic components further connected to this second DC bus. Advantageously, a current energy requirement of these other components is also taken into account rather than only an energy requirement and an energy supply of the second winding group alone.

According to an advantageous further development, a torque portion provided by the second winding group in the generator mode of the steering system motor is gradually reduced when the voltage applied to the second DC bus is exceeded, in particular by means of a PI controller (PI: proportional-integral). Advantageously, the torque portion provided by the second winding group in the generator mode of the steering system motor is gradually reduced when the voltage applied to the second DC bus is exceeded, until a system state is reached in which a maximum available torque is provided in the generator mode of the steering system motor and further advantageously the predefined limit value of the voltage applied to the second DC bus is adhered to. Advantageously, during a driving maneuver in which the system is in generator mode and the energy consumption of the other components connected to the second DC bus increases, the PI controller adapts to the new situation. In particular, the PI controller advantageously ensures in such a situation that the steering system motor recuperates more strongly by means of the second winding group and thus in particular allows more recovery, which advantageously allows a higher damping power to compensate for the additional consumption of the components connected to the second DC bus—in particular like a voltage regulator or similar to a voltage regulator.

In particular, it is provided that the steering system motor is a motor of a feedback actuator in a steer-by-wire steering system or a motor of a steering actuator acting on a coupling element, in particular a rack, in an electromechanical steering system, wherein the steering actuator is coupled via a steering shaft arrangement to the steering handle.

In some embodiments, the electromechanical steering system furthermore comprises a steering system motor, which is coupled to a steering handle of the steering system, and which, during operation of the steering system in a motor vehicle, is designed to influence a steering behavior, in particular a steering resistance torque, of the steering handle by means of a motor mode or by means of a generator mode. The steering system motor comprises a first winding group with three first phases and a second winding group with three second phases. During operation of the steering system, the steering system motor is further designed in such a way that the first winding group and the second winding group can be activated separately from each other, the first via a first circuit arrangement with an assigned first control unit, and the second via a second circuit arrangement with an assigned second control unit, wherein the steering system motor comprises in particular the first circuit arrangement and the first control unit, and the second circuit arrangement and the second control unit, and, furthermore, is designed, during operation of the steering system in a motor vehicle, to be operated according to a method designed according to the invention. In particular, the control units assigned to the steering system motor are designed to activate the first winding group differently from the second winding group when a torque, which requires a generator mode of the steering system motor, is intended to be provided by the steering system motor. The control units assigned to the steering system motor are further designed in particular to perform a torque redistribution between the first winding group and the second winding group, and to permit a greater negative current flow with respect to the first winding group than with respect to the second winding group. This advantageously leads to the advantages described in conjunction with the corresponding method features, which also apply correspondingly to the proposed steering system. In particular, the electromechanical steering system comprises the first circuit arrangement and the first control unit as well as the second circuit arrangement and the second control unit, wherein, in particular, at least the first circuit arrangement and the second circuit arrangement are included by the steering system motor of the electromechanical steering system, and further, in particular, the first circuit arrangement and the first control unit as well as the second circuit arrangement and the second control unit of the steering system motor are included by the electromechanical steering system. An advantageous refinement of the electromechanical steering system provides that the steering system motor is the motor of a steering actuator of the steering system, the steering actuator acting on a coupling element of the steering system, in particular a rack of the steering system, the steering actuator being mechanically connected to the steering handle, in particular via a steering shaft arrangement.

According to an advantageous refinement variant, the steering system is a steer-by-wire steering system, wherein the steering system motor is the motor of a feedback actuator, wherein the motor is mechanically coupled to a steering shaft, on which the steering handle is arranged. The motor of the feedback actuator can be coupled to the steering shaft, in particular via a transmission arrangement.

In some embodiments, the motor vehicle furthermore comprises a steering system according to the invention, in particular a steering system comprising a steering system motor which is designed to be operated according to a method according to the invention. Furthermore, the motor vehicle comprises at least a first DC voltage source and a second DC voltage source, wherein the first winding group of the steering system motor of the steering system is connected via a first DC bus of the motor vehicle to the first DC voltage source, and the second winding group of the steering system motor of the steering system is connected via a second DC bus of the motor vehicle to the second DC voltage source. The steering system according to the invention advantageously enables a generator mode of the steering system motor, with damage due to negative currents, i.e. in particular due to currents generated in the generator mode, being avoided. In particular, it is provided that the first DC voltage source is a vehicle battery, wherein the first DC voltage source is designed to receive a current generated by the first winding group of the steering system motor. In particular, the vehicle battery in the motor vehicle is not designed to provide the energy required for driving wheels of the motor vehicle. Furthermore, in particular, the vehicle battery is a 12 V car battery, in particular what is referred to as a “starter battery”, more particularly an AGM battery. The second DC voltage source, on the other hand, is advantageously a drive battery, i.e., in particular a battery, which is set up in the motor vehicle to provide energy for driving wheels of the motor vehicle. In particular, the drive battery is connected to the second DC bus via a unidirectional DC-DC converter. The connection via a cost-effective unidirectional DC-DC converter to the second DC bus is made possible in particular by the steering system designed according to the invention, which prevents currents generated by the steering system motor in a generator mode of the steering system motor from damaging the unidirectional DC-DC converter.

In the various figures, identical parts are generally provided with the same reference signs and are therefore also, in some cases, each explained only in conjunction with one of the figures.

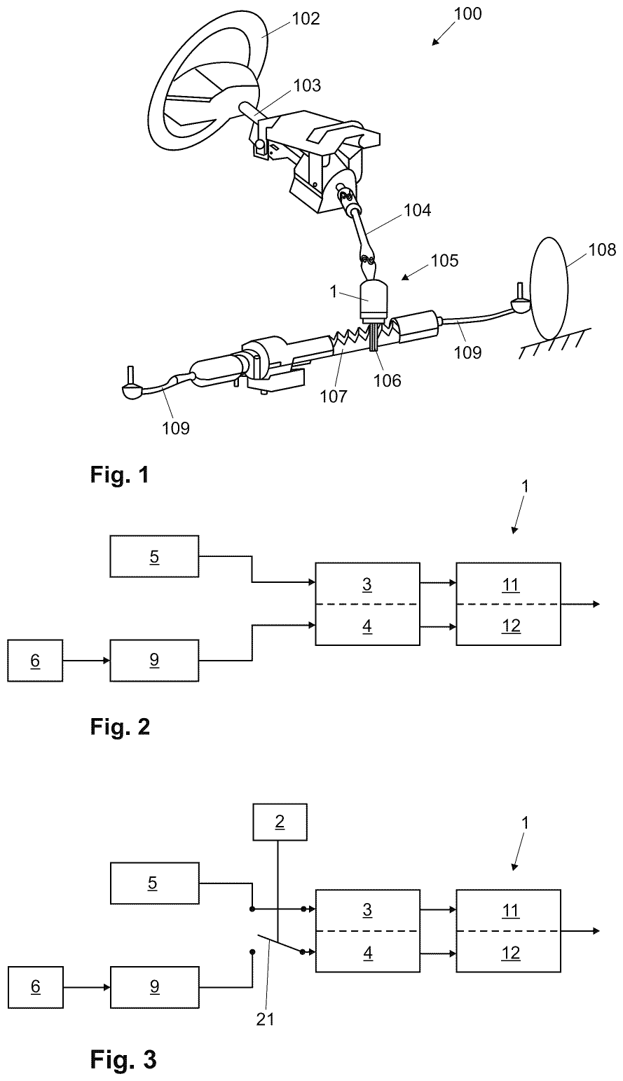

FIG. 1 shows an exemplary embodiment of an electromechanical steering system 100 of a motor vehicle. The steering system 100 comprises a steering column with an upper steering shaft 103, at the upper end of which a steering handle 102 designed as a steering wheel is arranged for conjoint rotation therewith. The upper steering shaft 103 together with a lower steering shaft 104 forms a steering shaft construction, which is mechanically coupled to steerable wheels 108 via a steering gear. In this exemplary embodiment, the steering gear comprises a steering actuator 105 having a steering system motor 1, which is designed, with appropriate activation, to drive a steering pinion 106, and a coupling element 107 designed as a rack. The steering pinion 106 acts on the coupling element 107, so that a rotational movement of the steering pinion 106 causes a translational movement of the coupling element 107 along its longitudinal axis. In this exemplary embodiment, the coupling rod 107, which moves linearly along its longitudinal axis, is mechanically coupled on both sides to a track rod 109. In turn, the track rods 109 are each mechanically coupled to the steerable wheels 108. If a steering input is made by turning the steering handle 102, the steering system motor 1 of the steering actuator 105, which steering system motor is mechanically coupled to the steering handle 102, can therefore be used to convert the steering input, in particular taking into account other recorded input variables, into a steering movement of the steerable wheels 108.

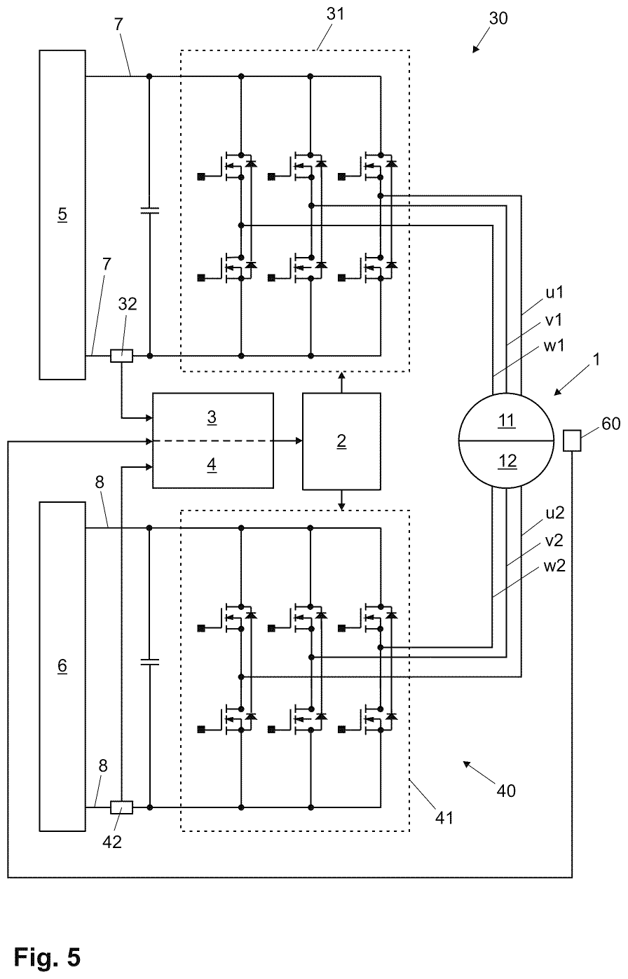

To increase the failure safety, the steering system motor 1 of the steering actuator and the components required for activating the steering system motor 1 are designed redundantly, in particular as outlined in the exemplary embodiment according to FIG. 5. The steering system motor 1 comprises a first winding group with three first phases and a second winding group with three second phases. In addition, for the activation, the steering system motor 1 is assigned a first circuit arrangement with a first control unit and a second circuit arrangement with a second control unit, which in particular can also be included by the steering system motor 1. The steering system motor 1 is designed in such a way that, during operation of the steering system 100, the first winding group can be activated via the first circuit arrangement by the first control unit, and the second winding group can be activated via the second circuit arrangement by the second control unit. The first control unit and the second control unit receive the same or at least comparable input variables, and, with them being taken into account, the control units can activate the first winding group and the second winding group in each case separately from each other.

During operation of the steering system 100 in a motor vehicle, in particular in a passenger vehicle, the steering system motor 1 of the steering actuator 105 is generally operated in a motor mode for the conversion of a steering input, wherein the steering behavior of the steering handle 102 is influenced by the steering system motor 1 by means of the mechanical coupling of the steering actuator 105 to the steering handle 102. In the motor mode of the steering system motor 1, the first winding group and the second winding group are activated in the same manner such that both winding groups provide a substantially identical torque, from which the overall torque is then additively composed.

During the operation of a motor vehicle, however, in particular situations also arise in which the steering system motor 1 is operated in a generator mode, in particular so that the steering system motor acts as a motor brake, for example to apply a steering resistance torque to the steering handle 102, and thus to influence the steering behavior of the steering handle 102. In the generator mode of the steering system motor 1, in comparison to the motor mode, a torque redistribution between the first winding group and the second winding group is carried out in such a way that the first winding group is activated differently from the second winding group, and the first winding group provides a greater proportion of the torque to be provided in the generator mode than the second winding group, and thus a greater negative current flow is permitted with respect to the first winding group than with respect to the second winding group. With respect to the second winding group, the activation is carried out in such a way that a negative current flow is limited to a predetermined limit value.

An exemplary embodiment of a method for operating a steering system motor is described below with reference to FIG. 2 and FIG. 3, wherein in particular also the steering system motor 1 from the exemplary embodiment according to FIG. 1, as described with reference to FIG. 2 and FIG. 3, can be operated. FIG. 2 shows a motor mode of a steering system motor 1 and FIG. 3 shows a generator mode of the steering system motor 1.

In the exemplary embodiments shown in FIG. 2 and FIG. 3, the steering system motor 1 in each case comprises a first winding group 11 with three first phases and a second winding group 12 with three second phases, wherein the first winding group 11 and the second winding group 12 are activated separately from each other, the first via a first circuit arrangement (not explicitly illustrated in FIG. 2 and FIG. 3) by a first control unit 3, and the second via a second circuit arrangement (not explicitly illustrated in FIG. 2 and FIG. 3) by a second control unit 4. The first control unit 3 and the second control unit 4 are designed in the exemplary embodiments as an ECU (ECU: Electronic Control Unit).

In the exemplary embodiments shown in FIG. 2 and FIG. 3, the first circuit arrangement with the first control unit 3 is connected to a first DC voltage source 5, which provides the energy required for a motor mode of the first winding group 11 and is designed as a vehicle battery, which does not provide any energy required for driving wheels of the motor vehicle. The vehicle battery may be designed in particular as an AGM battery.

In the exemplary embodiments shown in FIG. 2 and FIG. 3, the second circuit arrangement with the second control unit 4 is connected via a unidirectional DC-DC converter 9 to a second DC voltage source 6, which, via the unidirectional DC-DC converter 9, provides the energy required for a motor mode of the second winding group 12 and is designed as a drive battery, which provides energy required for driving wheels of a motor vehicle.

In the motor mode of the steering system motor 1 shown in FIG. 2, a uniform torque distribution takes place between the first winding group 11 and the second winding group 12. If, for example, a torque of 5 Nm is required by the steering system motor 1, the winding groups 11, 12 are activated via the control units 3, 4 in such a way that a torque of 2.5 Nm is provided by each winding group, and therefore the required overall torque of 5 Nm is cumulatively provided.

By contrast, in a generator mode of the steering system motor 1, in which an electrical current is generated by the steering system motor 1, a torque redistribution between the first winding group 11 and the second winding group 12 takes place, as illustrated in FIG. 3. In this case, the first winding group 11 is activated differently from the second winding group 12 by a switching element 21 opening by means of a torque distribution unit 2 when changing from a motor mode to a generator mode and thus interrupting the electrically conductive connection between the unidirectional DC-DC converter 9 and the circuit arrangement with the second control unit 4. This prevents a negative current flow from occurring at the second winding group 12. At the first winding group 11, on the other hand, a negative current flow is permitted, wherein the first DC voltage source 5, which is designed as a vehicle battery, converts the energy generated by the first winding group 11 in the generator mode and thus renders it harmless. If a change is made again to a motor mode, the operation takes place again, as shown in FIG. 2.

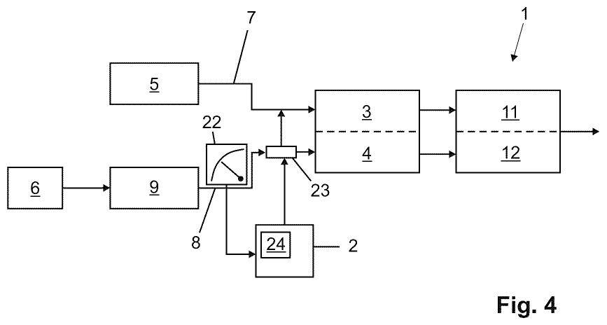

A refinement variant for the generator mode of the steering system motor 1, as explained with reference to FIG. 3, is outlined in FIG. 4 and is explained below. In this refinement variant, it is provided that the first circuit arrangement with the first control unit 3 is connected via a first DC bus 7 to the first DC voltage source 5 designed as a vehicle battery and the second circuit arrangement with the second control unit 4 is connected via a second DC bus 8 and the DC-DC converter 9 to the second DC voltage source 6 designed as a drive battery. By means of a voltage measuring unit 22, a voltage applied to the second DC bus 8 is detected during the generator mode of the steering system motor 1. The torque redistribution between the first winding group 11 and the second winding group 12 takes place taking into account the voltage applied to the second DC bus 8.

Using the torque distribution unit 2, it is monitored whether the detected voltage exceeds a predefined limit value. If the voltage applied to the second DC bus 8 exceeds the predefined limit value, then using the torque distribution unit 2 and the switching element 23, on which the torque distribution unit 2 can act, the torque redistribution from the second winding group 12 to the first winding group 11 of the steering system motor 1 is carried out in such a way that the voltage applied to the second DC bus 8 is returned to the predefined limit value for the voltage and complies with the predefined limit value. It is provided in this exemplary embodiment that a torque portion provided by the second winding group in the generator mode of the steering system motor 1 is gradually reduced when the voltage applied to the second DC bus 8 is exceeded by means of a PI controller 24, until the voltage applied to the second DC bus 8 again complies with the predefined limit value. From the second winding group 12, in most operating cases, a torque portion can advantageously continue to be provided, in particular without a negative current flow through the second winding group 12 becoming critical, because this negative current flow is advantageously absorbed by further electrical loads connected to the second DC bus (not explicitly shown in FIG. 4). Since the energy requirement of these electrical loads can fluctuate during operation, the damping torque provided by the second winding group 12 in the generator mode can also fluctuate and is adapted by means of the PI controller 24 in each case, wherein the torque distribution unit 2 acts with the PI controller 24 and the switching element 23 similar to a voltage regulator.

A further exemplary embodiment of a method for operating a steering system motor 1 in a motor vehicle is explained with reference to the steering system motor arrangement, illustrated in FIG. 5, in a motor vehicle. The redundantly designed steering system motor arrangement illustrated in FIG. 5 comprises a steering system motor 1, which has a first winding group 11 with three first phases u1, v1, w1 and a second winding group 12 with three second phases u2, v2, w2. The steering system motor 1 can be operated in a motor mode and in a generator mode. In addition, the steering system motor 1 is assigned a rotor position sensor 60, with which in particular a current speed of the steering system motor 1 can be detected. The steering system motor 1 may in particular be the motor of a steering actuator of a steering system of a motor vehicle, the steering actuator acting on a coupling element. Alternatively, the steering system motor 1 may in particular be the motor of a feedback actuator of a steer-by-wire steering system of a motor vehicle.

The steering system motor arrangement illustrated in FIG. 5 also comprises a first circuit arrangement 30 with a first control unit 3 assigned to said first circuit arrangement 30, a second circuit arrangement 40 with a second control unit 4 assigned to said second circuit arrangement 40, and a torque distribution unit 2. In addition, the steering system motor arrangement illustrated in FIG. 5 comprises a first DC voltage source 5 designed as a vehicle battery and a second DC voltage source 6, the second DC voltage source 6 being designed as a unidirectional DC-DC converter connected to a drive battery. The first circuit arrangement 30 is connected to the first DC voltage source 5 via a first DC bus 7, and the second circuit arrangement 40 is connected to the second DC voltage source 6 via a second DC bus 8.

The first circuit arrangement 30 and the second circuit arrangement 40 each comprise a first current measuring resistor 32 and a second current measuring resistor 42, in particular a first shunt and a second shunt, wherein it can be detected by means of the respective current measuring resistor 32, 42 whether a negative current flow occurs on the first DC bus 7 or on the second DC bus 8, i.e., in particular whether the first winding group 11 or the second winding group 12 is operated in a generator mode. The signals of the current measuring resistor 32 assigned to the first DC bus 7 are transmitted to the first control unit 3. The signals of the current measuring resistor 42 assigned to the second DC bus 8 are transmitted to the second control unit 4.

The first control unit 3 and the second control unit 4 also receive the signals from the rotor position sensor 60 assigned to the steering system motor 1. In addition, the control units 3, 4 also receive other input variables with respect to the torque to be provided by the steering system motor 1, which is not explicitly illustrated in FIG. 5. On the basis of the received input signals, the first control unit 3 and the second control unit 4 generate a request signal for the torque distribution unit 2 which, in turn, activates the first winding group 11 of the steering system motor 1 via a first inverter 31 of the first circuit arrangement 30 and activates the second winding group 12 of the steering system motor 1 via a second inverter 41 of the second circuit arrangement 40. By means of the first control unit 3 and the second control unit 4, the first winding group 11 and the second winding group 12 can be activated separately from each other.

If a negative current flow is not detected either by the first current measuring resistor 32 or by the second current measuring resistor 42, and thus no current is generated by the steering system motor 1, and the steering system motor 1 is thus operated overall in a motor mode, a uniform torque distribution between the first winding group 11 and the second winding group 12 takes place in the fault-free normal mode. The torque distribution unit 2 thus splits a requested torque to be converted by the steering system motor 1 equally between the first winding group 11 and the second winding group 12. By contrast, if a negative current flow is detected by means of the second current measuring resistor 42 on the second DC bus 8, a torque redistribution between the first winding group 11 and the second winding group 12 takes place, in which the first winding group 11 is activated differently from the second winding group 12. This is because a greater negative current flow can be permitted with respect to the first winding group 11 than with respect to the second winding group 12, because the first DC voltage source 5 is set up to receive and, in particular, to store energy generated by the first winding group 11, i.e., a negative current flow. By contrast, with respect to the second winding group 12 and the second DC bus 8, a negative current flow is limited to a predetermined limit value, because the unidirectional DC-DC converter of the second DC voltage source 6 is not designed to absorb energy generated by the second winding group 12 as a negative current flow, and may even be damaged by a negative current flow. Since a negative current flow on the second DC bus 8 cannot be dissipated in this respect, there would also be a risk that other electronic components connected to the second DC bus 8 would be damaged. The limit value is advantageously chosen in such a way that such damage is excluded.

In particular, in the situation in which, in the overall view, the steering system motor 1 is operated in a generator mode, the torque redistribution between the first winding group 11 and the second winding group 12 takes place in such a way that only the first winding group 11 is operated in the generator mode and only provides the torque required by the steering system motor 1, i.e., without support by the second winding group 12. The overall torque which can be provided by the steering system motor 1 during the generator mode of the steering system motor 1 is then limited to the torque which can be provided by the first winding group 11.

During the operation of the steering system motor 1, the first control unit 3 and the second control unit 4, in particular for the first winding group 11 and the second winding group 12, continuously determine an available torque, which can be provided by the first winding group 11 and the second winding group 12, respectively. Taking into account the torque which can be respectively provided by the first winding group 11 and the second winding group 12 under the above-described conditions, the torque distribution unit 2 then distributes a torque required by the steering system motor 1 to the first winding group 11 and the second winding group 12. This then results in the winding groups 11, 12 being operated asymmetrically in a generator mode of the steering system motor 1. After a generator mode, i.e., when a motor mode of the steering system motor 1 is resumed, the torque is then immediately distributed again by the torque distribution unit 2 to the first winding group 11 and the second winding group 12. An asymmetrical distribution of the torque in a motor mode is provided in particular if a fault not permitting a uniform distribution occurs.

The exemplary embodiments illustrated in the figures and explained in conjunction therewith serve to explain the invention and have no limiting effect thereon.

### LIST OF REFERENCE SIGNS

1 Steering system motor
11 First winding group
12 Second winding group
u1, v1, w1 Phases of the first winding group (11)
u2, v2, w2 Phases of the second winding group (12)
2 Torque distribution unit
21 Switching element
22 Voltage measuring unit
23 Circuit element
24 PI controller
3 First control unit
30 First circuit arrangement
31 First inverter
32 Current measuring resistor
4 Second control unit
40 Second circuit arrangement
41 Second inverter
42 Current measuring resistor
5 First DC voltage source
6 Second DC voltage source
7 First DC bus
8 Second DC bus
9 Unidirectional DC-DC converter
60 Rotor position sensor
100 Electromechanical steering system
102 Steering handle
103 Upper steering shaft
104 Lower steering shaft
105 Steering actuator
106 Steering pinion
107 Coupling rod
108 Steerable wheel
109 Track rod

1. A method for operating a steering system motor in a motor vehicle, wherein the steering system motor is coupled to a steering handle, the method comprising:
during operation of the motor vehicle, influencing, by the steering system motor, a steering behavior of the steering handle by a motor mode or a generator mode;
wherein the steering system motor comprises a first winding group with three first phases and a second winding group with three second phases;
wherein the first winding group and the second winding group are activated separately from each other, the first via a first circuit arrangement with an assigned first control unit, and the second via a second circuit arrangement with an assigned second control unit;
wherein the first circuit arrangement is connected to a first DC voltage source, which provides the energy required for a motor mode of the first winding group;
wherein the second circuit arrangement is connected to a second DC voltage source, which provides the energy required for a motor mode of the second winding group;
wherein for a torque which is to be provided by the steering system motor and requires a generator mode of the steering system motor, a torque redistribution between the first winding group and the second winding group takes place;
wherein the first winding group is activated differently from the second winding group;
wherein a greater negative current flow is permitted with respect to the first winding group than with respect to the second winding group.

2. The method as claimed in claim 1, wherein, in the generator mode of the steering system motor, the torque redistribution between the first winding group and the second winding group furthermore takes place in such a way that the generator mode of the steering system motor is implemented up to a defined specification solely by the first winding group.

3. The method as claimed in claim 2, wherein, in the generator mode of the steering system motor, the second winding group is deactivated up to the defined specification.

4. The method as claimed in claim 1, wherein, with respect to the second winding group, a negative current flow is limited to a predetermined limit value.

5. The method as claimed in claim 1, wherein, in the generator mode of the steering system motor, the overall torque which can be provided by the steering system motor is limited to a torque which can be provided by the first winding group.

6. The method as claimed in claim 1, wherein the first circuit arrangement is connected via a first DC bus to the first DC voltage source and the second circuit arrangement is connected via a second DC bus to the second DC voltage source, wherein the torque redistribution between the first winding group and the second winding group takes place if a negative current flow is detected on the second DC bus.

7. The method as claimed in claim 1, wherein the first circuit arrangement is connected via a first DC bus to the first DC voltage source and the second circuit arrangement is connected via a second DC bus to the second DC voltage source, wherein a voltage applied to the second DC bus is monitored, wherein the torque redistribution between the first winding group and the second winding group takes place taking into account the voltage applied to the second DC bus.

8. The method as claimed in claim 7, wherein the torque redistribution occurs when the voltage applied to the second DC bus exceeds a predefined limit value.

9. The method as claimed in claim 8, wherein the torque redistribution is carried out in such a way that the voltage applied to the second DC bus complies with the predefined limit value.

10. The method as claimed in claim 8, wherein a torque portion provided by the second winding group in the generator mode of the steering system motor is gradually reduced when the voltage applied to the second DC bus is exceeded by a PI controller, until a system state is reached in which a maximum available torque is provided in the generator mode of the steering system motor and the predefined limit value of the voltage applied to the second DC bus is adhered to.

11. The method as claimed in claim 1, wherein, in the generator mode of the steering system motor, the first DC voltage source receives energy generated by the first winding group.

12. The method as claimed in claim 1, wherein the first DC voltage source is a vehicle battery which does not provide any energy required for driving wheels of the motor vehicle.

13. The method as claimed in claim 1, wherein the second DC voltage source is a drive battery which provides energy required for driving wheels of the motor vehicle, the drive battery being connected to the second circuit arrangement via a unidirectional DC-DC converter.

14. The method as claimed in claim 1, wherein, in a fault-free motor mode of the steering system motor, a uniform torque distribution between the first winding group and the second winding group takes place.

15. The method as claimed in claim 1, wherein, during operation of the steering system motor, the control units of the steering system motor determine an available torque for the first winding group and the second winding group, with a torque distribution unit distributing a required torque to the first winding group and the second winding group, taking into account the torque available for the first winding group and the second winding group.

16. An electromechanical steering system, comprising:
a steering system motor, which is coupled to a steering handle of the steering system, and which, during operation of the steering system in a motor vehicle, is designed to influence a steering behavior of the steering handle by a motor mode or by a generator mode;
wherein the steering system motor includes a first winding group with three first phases and a second winding group with three second phases;
wherein, during operation of the steering system, the steering system motor is further designed in such a way that the first winding group and the second winding group can be activated separately from each other, the first via a first circuit arrangement with an assigned first control unit of the steering system, and the second via a second circuit arrangement with an assigned second control unit of the steering system;
wherein the steering system motor is further designed, during operation of the steering system in a motor vehicle, to be operated according to the method as claimed in claim 1.

17. The electromechanical steering system as claimed in claim 16, wherein the steering system motor is the motor of a steering actuator of the steering system, the steering actuator acting on a coupling element and being mechanically connected to the steering handle.

18. The electromechanical steering system as claimed in claim 16, wherein the steering system is a steer-by-wire steering system, wherein the steering system motor is the motor of a feedback actuator, wherein the motor is mechanically coupled to a steering shaft, on which the steering handle is arranged.

19. A motor vehicle, comprising:
an electromechanical steering system as claimed in claim 16; and
at least a first DC voltage source and a second DC voltage source;
wherein the first winding group of the steering system motor of the steering system is connected via a first DC bus of the motor vehicle to the first DC voltage source, and the second winding group of the steering system motor of the steering system is connected via a second DC bus of the motor vehicle to the second DC voltage source.

20. The motor vehicle as claimed in claim 19, wherein the first DC voltage source is a vehicle battery, which does not provide any energy required for driving wheels of the motor vehicle, wherein the first DC voltage source is designed to receive a current generated by the first winding group of the steering system motor, and wherein the second DC voltage source is a drive battery which provides energy required for driving wheels of the motor vehicle, the drive battery being connected via a unidirectional DC-DC converter to the second DC bus.
